(19) United States
(12) Patent Application Publication
(10) Pub. No.: US 2007/0019401 A1
(43) Pub. Date: Jan. 25, 2007

(54) PACKAGING ARRANGEMENT HAVING PACKAGE FEATURES FOR BIASING A SWITCH FROM AN ON MODE TO AN OFF MODE

(75) Inventors: Michael J. Liebowitz, Concord, CA (US); Phillip H. Neal, San Rafael, CA (US)

Correspondence Address: MICHAEL E. WOODS;PATENT LAW OFFICES OF MICHAEL E. WOODS, 112 BARN ROAD, TIBURON, CA, 94920-2602, US

(73) Assignee: Go Products, Inc., Greenbrae, CA (US)

(21) Appl. No.: 11/308,860

(22) Filed: May 16, 2006

Related U.S. Application Data
(60) Provisional application No. 60/594,939, filed on May 20, 2005.
(60) Provisional application No. 60/594,937, filed on May 20, 2005.
(60) Provisional application No. 60/594,940, filed on May 20, 2005.
(60) Provisional application No. 60/594,938, filed on May 20, 2005.

(51) Int. Cl. F21V 33/00; B26B 19/46; F21V 23/04

(52) U.S. Cl. 362/154; 362/115; 362/119; 362/253; 362/394

(57) ABSTRACT

A package for an article of manufacture is provided, the article of manufacture incorporating a switch having an on/off mode controlled by a handle, the package includes a housing at least partially enclosing the article of manufacture and includes an aperture permitting manipulation of the handle to an ON position for the switch; and a biasing system provided in the package and coupled to the handle, the biasing system positioning the handle to an OFF position for the switch when the handle is not manipulated to the ON position.

### CROSS REFERENCE TO RELATED APPLICATIONS

The present application is related to and claims benefit of U.S. Application No. 60/594,939 entitled “Packaging Arrangement Having Package Features For Biasing A Switch From An On Mode To An Off Mode” filed 20 May 2005, and is related to U.S. application Ser. No. ______ (Attorney Docket 20035-7010) entitled “Switching Illuminating Nail Clippers,” filed concurrently that claims benefit of U.S. Application No. 60/594,937 entitled “Switching Illuminating Nail Clippers,” filed 20 May 2005, and is related to U.S. application Ser. No. ______ (Attorney Docket 20035-7011) entitled “Switching Illuminating Tweezers with Magnifier,” filed 20 May 2005 that claims benefit of U.S. Application No. 60/594,940 entitled “Switching Illuminating Nail Clippers,” filed 20 May 2005, and is related to U.S. application Ser. No. ______ (Attorney Docket 20035-7012) entitled “Switching Illuminating Scissors,” filed concurrently that claims benefit of U.S. Application No. 60/594,938 entitled “Switching Illuminating Scissors,” filed 20 May 2005 filed 20 May 2005 and each incorporated by reference in their entireties for all purposes.

### BACKGROUND OF THE INVENTION

The present invention relates generally to the product packaging art, and more particularly, to a recess arrangement for a blister pack that allows a switch or button to be placed into an ‘ON’ position, and returns the control to an ‘OFF’ position automatically after trial.

Blister packs or cards, and variants thereof such as skin packs or packages, contour packs or packages, open boxes, and bubble packs or packages, are ubiquitous in the retail merchandising industry. Blister packaging generally refers to a method of packaging articles in transparent, thermoformed ‘blisters’ or pouches that range from precisely matching to generally matching or otherwise corresponding to the contours of the article to be packaged. The preformed (e.g. vacuum formed) blisters are made of thermoplastics such as vinyls (e.g. polyvinyl chloride (PVC)), polystyrene, or cellulosic plastics. They are typically placed inverted in fixtures, loaded with the articles, then cards coated with an adhesive are applied and sealed to the flanges of the blisters by use of heat and pressure.

The retail merchandising industry has embraced the so-called ‘try me’ marketing strategy whereby potential purchasers are invited to try out or otherwise test a product prior to making a purchase. In the case of electronically operated products, manufacturers must install batteries into the product when potential purchasers are to be able to activate or energize the product.

For instance, conventional systems provide a point-of-purchase display that permits a potential purchaser to temporarily energize a toy packaged within a blister-type packaging arrangement. The toy includes activation buttons which are accessible through an opening in the bottom of the package. The opening may be covered by a reinforced plastic membrane. Likewise, other systems provide a blister-type display package arrangement with recesses that permit a potential purchaser to squeeze an animated timepiece and thereby actuate a switch that causes the animated timepiece to actuate.

Further, other systems include blister-type packaging arrangements that have apertures to permit access to a product so that a potential purchaser can directly manipulate the product in some manner. For instance, one may include a blister package for a tape measure including an opening for accessing and withdrawing the measuring tape from the tape measure housing. Also included are packaging arrangements that permit access to a switch for activating battery-operated products such as toys, dolls, and the like.

Some articles or products incorporate a two-feature activation or on/off switch or button. A ‘press and hold’ feature of the switch permits the product to be energized and de-energized by simply depressing and releasing the on/off switch (e.g. a temporarily-on feature). A ‘press and slide’ feature of the switch permits the product to remain energized when the on/off switch is slid in a first direction and then released (e.g. a continuously-on feature). The product is deactivated by sliding the on/off switch in an opposing direction.

In the case of try-me packaging for an article having a two-feature on/off switch, retailers contemplate that a potential purchaser could inadvertently or maliciously slide the on/off switch into the continuously on position, thereby continuously energizing the article and expending or otherwise draining the batteries. Further, it is possible that the switch could slide into the continuously on position during shipment of the product from the manufacturer, thus draining the batteries prior to arriving at the retailer. It is less desirable to purchase a product with spent or discharged batteries, than a product with substantially fully charged batteries. Also, it is undesirable to provide for a ‘try me’ packaging campaign when the products are not properly operable due to drained or compromised batteries.

Further, for some articles certain types of ‘try me’ blister pack-type packaging arrangements are not suitable for use with articles or products that should remain in a sanitary state. That is, providing a hole or aperture through a blister in order to directly access a button or switch of the article, also serves to permit contaminates (pathological, biological, or otherwise) to reach the article.

There exist articles of manufacture, and classes of such articles that may advantageously be marketed in suitable ‘try me’ packaging except that the current ‘try me’ packaging solutions are unavailable or otherwise inadequate. Also, conventional systems in one sense often begin to evaluate packaging options after a design for an article of manufacture has been established. Thereafter, packaging considerations are typically able to reconfigure a design in minor, typically unimportant ways.

Accordingly, it is considered desirable to provide a new and improved retail package that permits a switch/button to be placed in an on position while returning the switch to the off position after package interaction. Additionally, what is desired is an article design paradigm that improves an ability of an article of manufacture to be advantageously marketed in a ‘Try Me’ package.

### BRIEF SUMMARY OF THE INVENTION

An object of the present invention is to provide a retail packaging arrangement (e.g., blister pack and the like) that permits a switch/button to be placed in a first position (e.g., ON) during package/article interaction while returning the control to a second position (e.g., OFF) automatically after the package/article interaction is complete. Another object of the present invention is to provide for a design paradigm for articles to enable interactive ‘try me’ packaging.

In accordance with one aspect of the present invention, a package for an article of manufacture is provided, the article of manufacture incorporating a switch having an on/off mode controlled by a handle, the package includes a housing at least partially enclosing the article of manufacture and includes an aperture permitting manipulation of the handle to an ON position for the switch; and a biasing system provided in the package and coupled to the handle, the biasing system positioning the handle to an OFF position for the switch when the handle is not manipulated to the ON position.

A preferred embodiment includes a method interacting with the article, the method including a) manipulating a handle controlling an on/off mode of a switch incorporated into an article of manufacture disposed in a package including a housing at least partially enclosing the article of manufacture to transition the switch to an ON mode; b) releasing the handle; and c) operating the handle to transition the switch to an OFF mode using a biasing subsystem provided in the package and coupled to the handle.

Another preferred embodiment includes disposing a handle coupled to a switch that controls a function of an article of manufacture peripherally to the article and providing that the switch responds to the handle near an extreme end-of-travel so that the handle may be moved when packaged through a limited range of motion (appropriate for the package and article) and a particular switch mode is engaged at the end-of-motion so that a biasing system may reposition the handle to engage an alternate switch mode suitable for non-operational retail presentation.

One advantage of the present invention is the provision of a new and improved packaging arrangement that prevents an on/off switch associated with a packaged article from being transitioned into a continuously-on position because the package automatically returns the switch to the desired off position after package/article interaction, suitable for non-operational retail presentation.

Another advantage of the present invention is the provision of a try-me packaging arrangement that is adaptable to articles different from those previously accommodated by try-me packaging.

Still another advantage of the present invention is the provision of a packaging arrangement that provides a biasing system for automatically returning a switch to an off position from an on position when a potential consumer completes the package interaction.

Yet another advantage of the present invention is the provision of a packaging arrangement that permits a potential purchaser to test or otherwise try-out a product at the point-of-purchase.

Yet a further advantage of the present invention is the provision of a try-me packaging arrangement that prevents batteries associated with the packaged product from being unduly drained or discharged during ‘try outs’ in the course of article evaluation.

Yet still a further advantage is a switching system close to a threshold, yet inactive, near an extreme end of range of movement, and using a lever arm, permits use of a biasing mechanism in the packaging that is relatively simpler and less inexpensive than would be the case with other configurations.

A still further advantage of the present invention is the provision of a packaging arrangement that prevents an on/off switch associated with a product from being moved into a continuously-on position during transit or shipment to a retailer.

Still further advantages of the present invention will become apparent to those of ordinary skill in the art upon reading and understanding the following detailed description of the preferred embodiment.

### BRIEF DESCRIPTION OF THE DRAWINGS

The invention may take form in various components and arrangements of components, and in various steps and arrangements of steps. The drawings are only for purposes of illustrating a preferred embodiment, and are not to be construed as limiting the invention.

FIG. 1 is a front plan view of a first exemplary article that is sealed within a blister-type packaging arrangement that incorporates the features of the present invention therein;

FIG. 2 is a front plan view of a second exemplary article that is sealed within a blister-type packaging arrangement that incorporates the features of the present invention therein; and

FIG. 3 is a front plan view of a third exemplary article that is sealed within a blister-type packaging arrangement that incorporates the features of the present invention therein.

### DETAILED DESCRIPTION OF THE INVENTION

The preferred embodiment of the present invention provides an apparatus and method for interactive ‘Try Me’ packaging. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

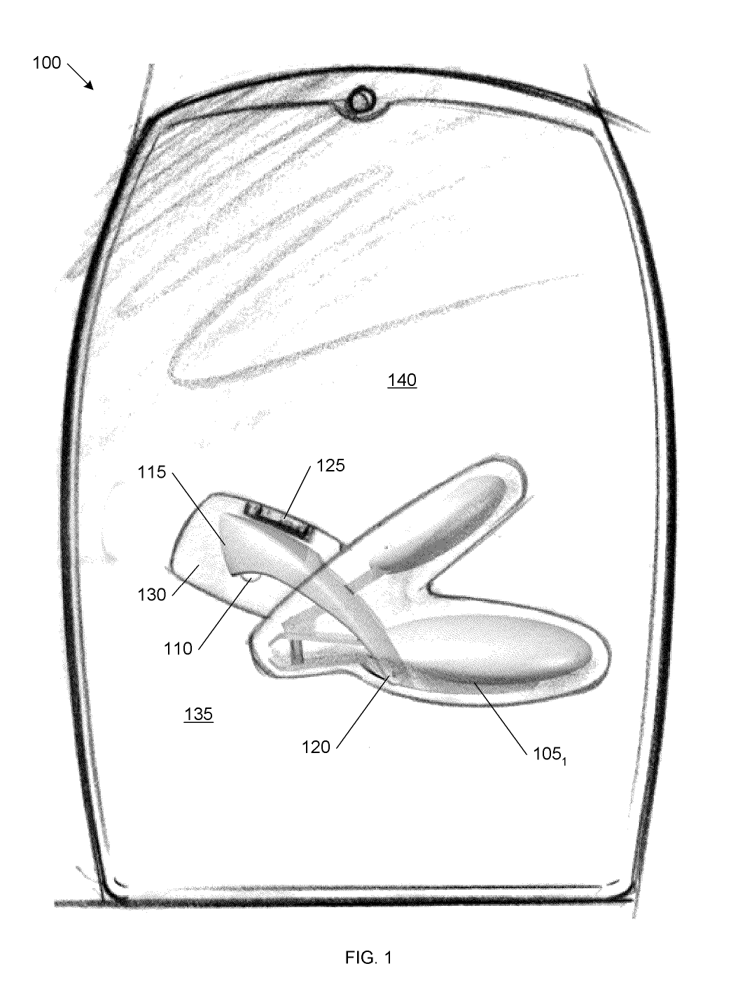

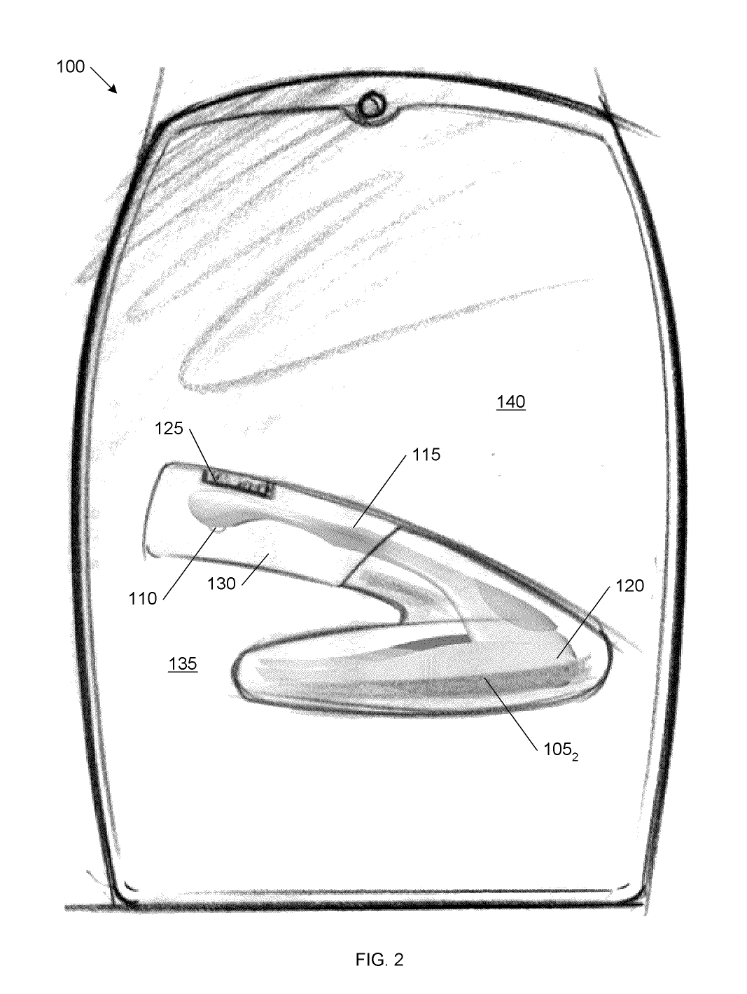

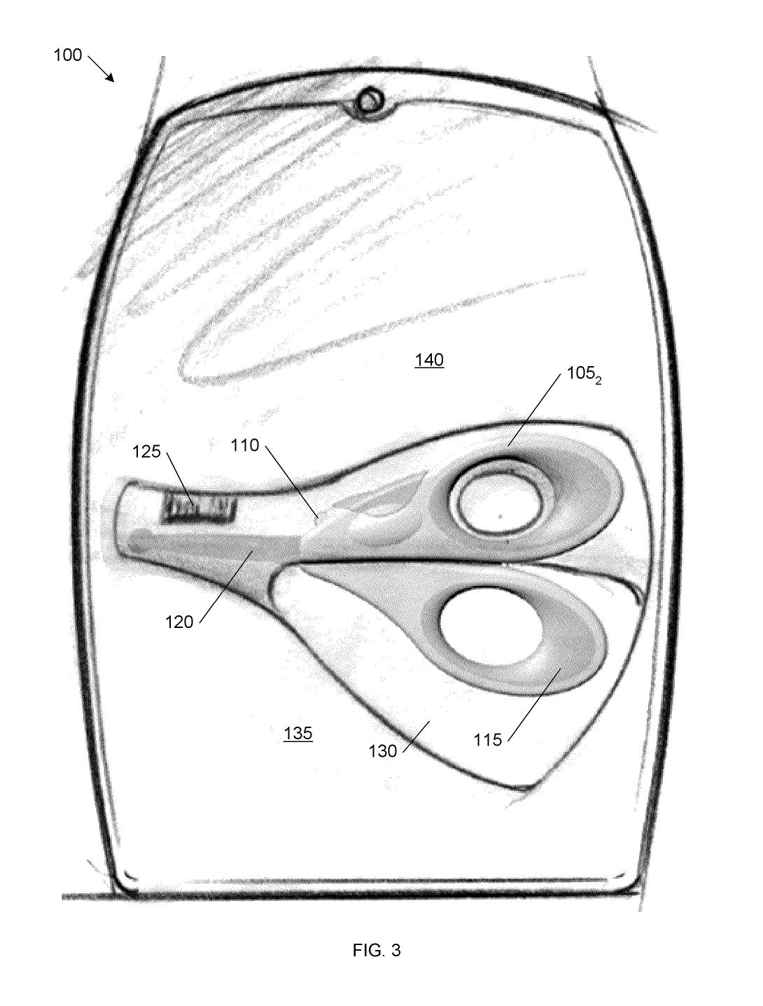

Referring now to FIG. 1 through FIG. 3, there are shown exemplary embodiments of a try-me packaging system 100 enclosing an article of manufacture 105ᵢ (105₁ in FIG. 1 is an illuminating clippers, 105₂ in FIG. 2 is an illuminating tweezers, and 105₃ in FIG. 3 is an illuminating scissors) where packaging system 100 in these embodiments include a blister-type packaging arrangement. In the embodiments being described, article of manufacture 105ᵢ is a battery-operated product that includes an illumination source 110 that is activated and deactivated by an on/off switch (not shown) operated by a handle 115. Further details of the structure and operation of these representative articles of manufacture are available in the incorporated related patent applications referenced above.

Certain terminology is used herein to describe article of manufacture 105 and packaging system 100 for convenience in reference only, and is not to be construed as limiting. For example, as shown in FIG. 1 through FIG. 3, article 105 is entrapped within packaging system 100 in a manner to hold a pivot point 120 fixed and to position handle 115 proximate a biasing subsystem 125 and to provide extra-package access to handle 115 by use of an aperture/cutout 130 in a cover (shown generally as 135) of packaging system 100. In this configuration, suitable for shipping and for extended-term retail shelf presentation, illumination source 110 is inactive. During interaction, a user may manipulate and move handle 115 to an ‘ON’ position that both activates illumination source 110 and engages biasing subsystem 125 against handle 115. In this manner, the user may hold handle 115 in the ON mode sufficient to maintain activation for illumination source 110, but upon releasing handle 115, biasing subsystem 125 automatically returns handle 115 to a position that deactivates illumination source 110. In the preferred embodiments, cover 135 overlays and secures article of manufacture 105 except for the region encompassed by aperture 130.

An ‘operate to actuate’ feature of article of manufacture 105 that couples operation (e.g., light activation) to handle 115 coupled to a switch with the switch enabling a power source when handle 115 is positioned near a limit of operational movement permits product actuation through a small range of motion of handle 115. This is advantageous because both aperture 130 may be made smaller as would be useful with a larger range of actuation, and biasing subsystem 125 may be simplified as it has a requirement to move handle 115 through a smaller range of motion (from the on to the off position). Article of manufacture 105 is to be energized by moving handle 115 and holding it against biasing subsystem 125 which activates illumination source 110. Article of manufacture 105 is de-energized by simply releasing handle 115 as biasing subsystem 125 returns handle 115 to a location that turns the switch off.

As is customary for blister-type packaging used in the preferred embodiment for packaging system 100, article of manufacture is packaged for sale with a backing card 140, such as a conventional paperboard backing card, that is visible through cover 135. As known in the art, and as may be used in the embodiments being described, flanges of cover 135 may be adhesively bonded to backing card 140 in a conventional manner. A blister of cover 135 is molded into an appropriate shape to receive article of manufacture 105 with conventional techniques such as vacuum molding. In addition, the blister may be formed from conventional thermoplastic materials such as vinyls (e.g. polyvinyl chloride (PVC)), polystyrene, or cellulosic plastics. As is known in the art, the blister is some-what flexible and resilient. That is, the blister will resiliently return to its original shape when slightly deformed and released. Backing card 140 includes, in the preferred embodiments, graphics and other signage and indicators that help potential consumers understand and use packaging system 100, such as the “Try Me” features available.

A ‘try-me’ feature of packaging system 100 permits a potential purchaser to demonstrate the illumination system by activating article of manufacture 105 at the point-of-purchase. The ‘try-me’ feature includes aperture 130 permitting access to, and manipulation of, handle 115 to control illumination source 110 as described above. Biasing subsystem 125 ensures that the illumination system does not remain active beyond a duration required by the prospective consumer.

The invention has been described with reference to the preferred embodiment. Modifications and alterations will occur to others upon reading and understanding the preceding detailed description. It is intended that the invention be construed as including all such modifications and alterations insofar as they come within the scope of the appended claims or the equivalents thereof. For instance, while article of manufacture 105 has been described and illustrated as one of a collection of personal care implements, it is contemplated that arrangements of packaging system 100 implementing embodiments of the present invention may be used with other types of packaged articles. Further, the packaging arrangement has been described and illustrated with a blister-type cover. However, it is contemplated that the recess arrangement of the present invention is equally suitable for use with packaging materials other that thermoplastic blister covers, as well as other packaging types in which may be adapted as described herein.

Providing the a triggering system close to a threshold, near an extreme end of range of movement, and using a lever arm, permits the biasing mechanism in the packaging to be implemented efficiently and inexpensively. For example, foam may be adhered to appropriate portions of a package in contact with the actuating handle. Other biasing systems, e.g., metal springs and the like, may also be used. This configuration permits light force, short distance biasing systems to be used that are often quite simple, effective, virtually error-free, and inexpensive.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to ‘one embodiment’, ‘an embodiment’, or ‘a specific embodiment’ means that a particular feature, structure, or characteristic described in connection with the embodiment is included in at least one embodiment of the present invention and not necessarily in all embodiments. Thus, respective appearances of the phrases ‘in one embodiment’, ‘in an embodiment’, or ‘in a specific embodiment’ in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope of the present invention to implement a program or code that may be stored in a machine-readable medium or transmitted using a carrier wave to permit a computer to perform any of the methods described above.

Additionally, any signal arrows in the drawings/Figures should be considered only as exemplary, and not limiting, unless otherwise specifically noted. Furthermore, the term ‘or’ as used herein is generally intended to mean ‘and/or’ unless otherwise indicated. Combinations of components or steps will also be considered as being noted, where terminology is foreseen as rendering the ability to separate or combine is unclear.

As used in the description herein and throughout the claims that follow, ‘a’, ‘an’, and ‘the’ includes plural references unless the context clearly dictates otherwise. Also, as used in the description herein and throughout the claims that follow, the meaning of ‘in’ includes ‘in’ and ‘on’ unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

The above-described arrangements of apparatus and methods are merely illustrative of applications of the principles of this invention and many other embodiments and modifications may be made without departing from the spirit and scope of the invention as defined in the claims.

These and other novel aspects of the present invention will be apparent to those of ordinary skill in the art upon review of the drawings and the remaining portions of the specification. Therefore, the scope of the invention is to be determined solely by the appended claims.

What is claimed as new and desired to be protected by Letters Patent of the United States is:

1. In combination, a package and an article incorporating a switch having an on/off mode controlled by a handle, the package comprising a cover at least partially enclosing the article and including an aperture permitting manipulation of the handle to an ON position for the switch, and a biasing arrangement formed in the package proximate the handle, the biasing arrangement urging the handle to an OFF position for the switch.

2. The combination of claim 1, wherein the handle is a lever attached to the switch for pivotal operation.

3. The combination of claim 2, wherein the biasing arrangement includes a biasing structure disposed in contact with the lever when the lever is rotated so that the switch is in the ON position.

4. The combination of claim 3 wherein the biasing material is a foam material.

5. In combination, a package and an article incorporating a switch having an on/off mode controlled by a handle, the package comprising a cover at least partially enclosing the article and adapted to permit manipulation of the handle to an ON position for the switch, and a biasing arrangement formed in the package proximate the handle, the biasing arrangement urging the handle to an OFF position for the switch.

6. The combination of claim 5, wherein the cover is formed from a thermoplastic material and wherein the biasing arrangement is arranged in the cover.

7. The combination of claim 5, further including a backing card adhesively bonded to the cover and wherein the biasing arrangement is arranged in the backing card.

8. The combination of claim 5, wherein the article includes a battery-operated illumination subsystem controlled by the switch.

9. The combination of claim 8 wherein the article includes a nail clipper.

10. The combination of claim 8 wherein the article includes a tweezers.

11. The combination of claim 8 wherein the article includes a scissors.

12. The combination of claim 1 wherein the biasing arrangement pushes the handle.

13. The combination of claim 5 wherein the biasing arrangement pulls the handle.

14. In combination, a package and an article incorporating a switch having an on/off mode controlled by a handle, the package comprising a housing at least partially containing the article and including an aperture permitting manipulation of the handle to an ON position for the switch, and a biasing arrangement formed in the package coupled to the handle, the biasing arrangement urging the handle to an OFF position for the switch.

15. The combination of claim 14, wherein the handle is a lever attached to the switch for pivotal operation.

16. The combination of claim 15, wherein the biasing arrangement includes a biasing structure disposed in contact with the lever when the lever is rotated so that the switch is in the ON position.

17. The combination of claim 16 wherein the biasing material is a foam material.

18. The combination of claim 15 wherein the biasing material is an elastomeric band.

19. An apparatus, comprising:
a package for an article of manufacture, said article of manufacture incorporating a switch having an on/off mode controlled by a handle, said package including a housing at least partially enclosing said article of manufacture and including an aperture permitting manipulation of said handle to an ON position for the switch; and
a biasing system provided in said package and coupled to said handle, said biasing system positioning said handle to an OFF position for the switch when said handle is not manipulated to said ON position.

20. The apparatus of claim 19 wherein said handle is a lever attached to said switch for pivotal operation.

21. The apparatus of claim 20 wherein said biasing system includes a biasing structure disposed in contact with said lever when said lever is rotated so that said switch is in said ON position.

22. The apparatus of claim 21 wherein said biasing material is a foam material.

23. The apparatus of claim 21 wherein said biasing material is a elastomeric band.

24. The apparatus of claim 19 wherein said housing includes a cover wherein at least a portion of said cover is formed from a thermoplastic material and wherein at least a portion of said biasing system is arranged in said cover.

25. The apparatus of claim 19 wherein said housing includes a cover and a backing card and wherein said backing card is adhesively bonded to said cover and wherein said biasing system is incorporated into at least a portion of said backing card.

26. The apparatus of claim 19 wherein said article of manufacture includes a battery-operated illumination subsystem controlled by said switch.

27. The apparatus of claim 26 wherein said article of manufacture includes a nail clipper.

28. The apparatus of claim 26 wherein said article of manufacture includes a tweezers.

29. The apparatus of claim 26 wherein said article of manufacture includes a scissors.

30. The apparatus of claim 19 wherein said biasing system pushes said handle.

31. The apparatus of claim 30 wherein said biasing system includes a foam member.

32. The apparatus of claim 19 wherein said biasing system pulls the handle.

33. The apparatus of claim 32 where said biasing system includes an elastomeric band.

34. A method, the method comprising:
a) manipulating a handle controlling an on/off mode of a switch incorporated into an article of manufacture disposed in a package including a housing at least partially enclosing said article of manufacture to transition said switch to an ON mode;
b) releasing said handle; and
c) operating said handle to transition said switch to an OFF mode using a biasing subsystem provided in said package and coupled to said handle.

35. The method of claim 34 wherein said handle is a lever attached to said switch for pivotal operation.

36. The method of claim 35 wherein said biasing system includes a biasing structure disposed in contact with said lever when said lever is rotated so that said switch is in said ON position.

37. The method of claim 36 wherein said biasing material is a foam material.

38. The method of claim 36 wherein said biasing material is an elastomeric band.

39. The method of claim 34 wherein said housing includes a cover wherein at least a portion of said cover is formed from a thermoplastic material and wherein at least a portion of said biasing system is arranged in said cover.

40. The method of claim 34 wherein said housing includes a cover and a backing card and wherein said backing card is adhesively bonded to said cover and wherein said biasing system is incorporated into at least a portion of said backing card.

41. The method of claim 34 wherein said article of manufacture includes a battery-operated illumination subsystem controlled by said switch.

42. The method of claim 41 wherein said article of manufacture includes a nail clipper.

43. The method of claim 41 wherein said article of manufacture includes a tweezers.

44. The method of claim 41 wherein said article of manufacture includes a scissors.

45. The method of claim 34 wherein said biasing system pushes said handle.

46. The method of claim 45 wherein said biasing system includes a foam member.

47. The method of claim 34 wherein said biasing system pulls the handle.

48. The method of claim 47 where said biasing system includes an elastomeric band.

49. An article of manufacture, comprising:
means for manipulating a handle controlling an on/off mode of a switch incorporated into an article of manufacture disposed in a package to permit transition of said switch to an ON mode while disposed within said package; and
means for operating said handle to transition said switch to an OFF mode using a biasing subsystem provided in said package and coupled to said handle.
